(19) United States
(12) Patent Application Publication
(10) Pub. No.: US 2017/0211839 A1
(43) Pub. Date: Jul. 27, 2017

(54) BACK-UP POWER SOURCE APPARATUS IN INDOOR UNIT, CONTROLLING METHOD THEREOF AND MULTI-SPLIT AIR CONDITIONING SYSTEM

(71) Applicants: GD MIDEA HEATING & VENTILATING EQUIPMENT CO., LTD., Foshan (CN); MIDEA GROUP CO., LTD., Foshan (CN)

(72) Inventors: Zhanheng LIANG, Foshan (CN); Yanjing JIANG, Foshan (CN); Meibing XIONG, Foshan (CN)

(21) Appl. No.: 15/329,438

(22) PCT Filed: Mar. 16, 2015
(86) PCT No.: PCT/CN2015/074325

§ 371 Date: Jan. 26, 2017

(30) Foreign Application Priority Data
Dec. 9, 2014 (CN) 201410751099.9

(51) Int. Cl. F24F 11/00; F24F 1/00; H02J 7/00; H02J 9/06

(52) U.S. Cl. CPC F24F 11/0086; H02J 9/061; F24F 1/0003; H02J 7/0047; F24F 2011/0046

(57) ABSTRACT

A back-up power source apparatus in an indoor unit of a multi-split air conditioning system includes first and second voltage detecting circuits and a control circuit connected with the first and second voltage detecting circuits. The first and second voltage detecting circuits detect voltages of first and second power sources on a mainboard of the indoor unit in real time respectively, and the control circuit controls the back-up power source apparatus to enter a corresponding operation state according to the voltages of the first and/or second power sources. A controlling method of the back-up power source apparatus and a multi-split air conditioning system including the back-up power source apparatus are also provided.

### CROSS REFERENCE TO RELATED APPLICATION

This application claims priority and benefits of Chinese Patent Application No. 201410751099.9, filed with State Intellectual Property Office on Dec. 9, 2014, the entire content of which is incorporated herein by reference.

### FIELD

Embodiments of the present invention generally relate to a multi-split technology field, and more particularly to a back-up power source apparatus in an indoor unit of a multi-split air conditioning system, a multi-split air conditioning system including the back-up power source apparatus and a controlling method for the back-up power source apparatus in an indoor unit of a multi-split air conditioning system.

### BACKGROUND

In an application of a conventional multi-split air conditioning system, a power of an indoor unit of the multi-split air conditioning system is generally incorporated into a master power switch of a room due to limitations of an installation environment, an installation method, etc. However, when the master power switch of the room is turned off, the power of the indoor unit of the room fails, and an electronic expansion valve in the indoor unit remains in the current state. This results in a series of influences, such as a condensation of an evaporator in the indoor unit, an oil return abnormity of the multi-split air conditioning system, and a damage on a compressor in the outdoor unit due to a refrigerant hit, which make the multi-split air conditioning system work abnormally. Therefore, it is required to solve the problem of an independent power failure of the indoor unit.

Currently, the monitoring efforts of installing the multi-split air conditioning system are enhanced to avoid a wiring error, thus ensuring a normal and reliable operation of the multi-split air conditioning system, which, however, cannot remove negative influences of the independent power failure of the indoor unit of the multi-split air conditioning system.

### SUMMARY

Embodiments of the present invention seek to solve at least one of the problems existing in the related art to at least some extent.

Accordingly, a first object of the present disclosure is to provide a back-up power source apparatus in an indoor unit of a multi-split air conditioning system, in which a control circuit in the back-up power source apparatus may control the back-up power source apparatus to enter a corresponding operation state according to voltage(s) of a first power source and/or a second power source on the mainboard of the indoor unit, and which may remove negative influences of an independent power failure of the indoor unit and ensure a reliable operation of the multi-split air conditioning system.

A second object of the present disclosure is to provide a multi-split air conditioning system.

A third object of the present disclosure is to provide a controlling method for a back-up power source apparatus in an indoor unit of a multi-split air conditioning system.

In order to achieve the above objects, embodiments of a first aspect of the present disclosure provide a back-up power source apparatus in an indoor unit of a multi-split air conditioning system, including: a first voltage detecting circuit configured to detect a voltage of a first power source on a mainboard of the indoor unit in real time; a second voltage detecting circuit configured to detect a voltage of a second power source on the mainboard of the indoor unit in real time; a control circuit connected with the first voltage detecting circuit and the second voltage detecting circuit respectively and configured to control the back-up power source apparatus to enter a corresponding operation state according to the voltage of the first power source on the mainboard of the indoor unit and/or the voltage of the second power source on the mainboard of the indoor unit, in which the operation state comprises: a normal operation state, a protection operation state, a back-up operation state and an alarm operation state.

With the back-up power source apparatus in the indoor unit of the multi-split air conditioning system according to embodiments of the present disclosure, the first voltage detecting circuit may detect the voltage of the first power source on the mainboard of the indoor unit in real time, the second voltage detecting circuit may detect the voltage of the second power source on the mainboard of the indoor unit in real time, and the control circuit may control the back-up power source apparatus to enter the corresponding operation state according to the voltage of the first power source on the mainboard of the indoor unit and/or the voltage of the second power source on the mainboard of the indoor unit. Therefore, the back-up power source apparatus in the indoor unit of the multi-split air conditioning system according to embodiments of the present disclosure may determine whether the indoor unit has a power failure by detecting the voltages of the first power source and the second power source on the mainboard of the indoor unit in real time. If the supply of power of the indoor unit fails, the back-up power source apparatus according to embodiments of the present disclosure may enter the corresponding operation state, and thus the multi-split air conditioning system can operate normally even in case of a power failure of the indoor unit. In this way, a series of negative influences on the multi-split air conditioning system, which are caused by a fact that an electronic expansion valve in the indoor unit remains in the current state because of the independent power failure of the indoor unit, may be removed, thus ensuring a reliable operation of the multi-split air conditioning system. Further, the back-up power source apparatus in the indoor unit may be implemented completely by a weak current control, and thus can operate safely and reliably.

In some embodiments, if the voltage of the first power source on the mainboard of the indoor unit is less than a first predetermined voltage and the control circuit determines that a duration of the voltage of the first power source on the mainboard of the indoor unit less than the first predetermined voltage reaches a first predetermined time, the control circuit controls the back-up power source apparatus to enter the protection operation state; and if the back-up power source apparatus is in the protection operation state, the control circuit outputs a shutdown dry contact signal to a forced shutdown controller to force the indoor unit to execute a shutdown instruction.

In some embodiments, if the voltage of the second power source is less than a second predetermined voltage and the control circuit determines that a duration of the voltage of the second power source less than the second predetermined voltage reaches a first predetermined time, the control circuit controls the back-up power source apparatus to enter the alarm operation state; and if the back-up power source apparatus is in the alarm operation state, the control circuit outputs a shutdown dry contact signal to a forced shutdown controller to force the indoor unit to execute a shutdown instruction, and outputs an alarm dry contact signal to an alarm apparatus simultaneously to control the alarm apparatus to generate an alarm.

In some embodiments, the control circuit controls the back-up power source apparatus to enter the back-up operation state, if the voltage of the first power source on the mainboard of the indoor unit is less than a first predetermined voltage, the voltage of the second power source on the mainboard of the indoor unit is less than a second predetermined voltage, and the control circuit determines that a duration of the voltage of the first power source on the mainboard of the indoor unit less than the first predetermined voltage reaches a first predetermined time and a duration of the voltage of the second power source less than the second predetermined voltage reaches the first predetermined time; and if the back-up power source apparatus is in the back-up operation state, the control circuit controls the back-up power source apparatus to output a back-up power source to the mainboard of the indoor unit, to output a shutdown dry contact signal to a forced shutdown controller to force the indoor unit to execute a shutdown instruction, and to output an alarm dry contact signal to an alarm apparatus simultaneously to control the alarm apparatus to generate an alarm.

In some embodiments, if the voltage of the first power source on the mainboard of the indoor unit is larger than or equal to a first predetermined voltage and the voltage of the second power source on the mainboard of the indoor unit is larger than or equal to a second predetermined voltage, the control circuit controls the back-up power source apparatus to enter the normal operation state.

In some embodiments, the back-up power source apparatus further includes an indicator light module connected with the control circuit and configured to output an indication under a control of the control circuit.

In some embodiments, the indicator light module comprises a LED indicator light and the operation state further comprises a power-failure operation state, in which if the back-up power source apparatus is in the power-failure operation state, the LED indicator light is turned off; if the back-up power source apparatus is in the normal operation state, the LED indicator light is always on; if the back-up power source apparatus is in the protection operation state, the LED indicator light outputs an indication in a first manner; if the back-up power source apparatus is in the alarm operation state, the LED indicator light outputs an indication in a second manner; and if the back-up power source apparatus is in the back-up operation state, the LED indicator light outputs an indication in a third manner.

In some embodiments, the first power source on the mainboard of the indoor unit is configured as a 12V DC power source, and the second power source on the mainboard of the indoor unit is configured as a 5V DC power source.

In some embodiments, the back-up power source apparatus is further connected with an external DC power source, and the external DC power source is configured to supply power to the back-up power source apparatus.

In order to achieve the above objects, embodiments of a second aspect of the present disclosure provide a multi-split air conditioning system, and the multi-split air conditioning system includes a back-up power source apparatus in an indoor unit of a multi-split air conditioning system according to embodiments of the first aspect of the present disclosure.

With the above-identified back-up power source apparatus, the multi-split air conditioning system according to embodiments of the present disclosure can operate normally even in case of a power failure of the indoor unit. In addition, a series of negative influences on the multi-split air conditioning system, which are caused by a fact that an electronic expansion valve in the indoor unit remains in the current state because of the independent power failure of the indoor unit, may be removed, thus ensuring a reliable operation of the multi-split air conditioning system.

In order to achieve the above objects, embodiments of a third aspect of the present disclosure provide a controlling method for a back-up power source apparatus in an indoor unit of a multi-split air conditioning system, including: detecting a voltage of a first power source on a mainboard of the indoor unit and a voltage of a second power source on the mainboard of the indoor unit in real time; controlling the back-up power source apparatus to enter a corresponding operation state according to the voltage of the first power source on the mainboard of the indoor unit and/or the voltage of the second power source on the mainboard of the indoor unit, in which the operation state includes: a normal operation state, a protection operation state, a back-up operation state and an alarm operation state.

With the controlling method for the back-up power source apparatus in the indoor unit of the multi-split air conditioning system, the voltage of the first power source on the mainboard of the indoor unit and the voltage of the second power source on the mainboard of the indoor unit may be detected in real time, the back-up power source apparatus may be controlled to enter the corresponding operation state according to the voltage of the first power source on the mainboard of the indoor unit and/or the voltage of the second power source on the mainboard of the indoor unit, and thus the multi-split air conditioning system can operate normally even in case of a power failure of the indoor unit. In this way, a series of negative influences on the multi-split air conditioning system, which are caused by a fact that an electronic expansion valve in the indoor unit remains in the current state because of the independent power failure of the indoor unit, may be removed, thus ensuring a reliable operation of the multi-split air conditioning system.

In some embodiments, if the voltage of the first power source on the mainboard of the indoor unit is less than a first predetermined voltage and it is determined that a duration of the voltage of the first power source on the mainboard of the indoor unit less than the first predetermined voltage reaches a first predetermined time, the back-up power source apparatus is controlled to enter the protection operation state; and if the back-up power source apparatus is in the protection operation state, a shutdown dry contact signal is output to a forced shutdown controller to force the indoor unit to execute a shutdown instruction.

In some embodiments, if the voltage of the second power source on the mainboard of the indoor unit is less than a second predetermined voltage and it is determined that a duration of the voltage of the second power source less than the second predetermined voltage reaches a first predetermined time, the back-up power source apparatus is controlled to enter the alarm operation state; and if the back-up power source apparatus is in the alarm operation state, a shutdown dry contact signal is output to a forced shutdown controller to force the indoor unit to execute a shutdown instruction, and an alarm dry contact signal is output to an alarm apparatus simultaneously to control the alarm apparatus to generate an alarm.

In some embodiments, the back-up power source apparatus is controlled to enter the back-up operation state, if the voltage of the first power source on the mainboard of the indoor unit is less than a first predetermined voltage, the voltage of the second power source on the mainboard of the indoor unit is less than a second predetermined voltage, and it is determined that a duration of the voltage of the first power source on the mainboard of the indoor unit less than the first predetermined voltage reaches a first predetermined time and a duration of the voltage of the second power source less than the second predetermined voltage reaches the first predetermined time; and if the back-up power source apparatus is in the back-up operation state, the back-up power source apparatus is controlled to output a back-up power source to the mainboard of the indoor unit, to output a shutdown dry contact signal to a forced shutdown controller to force the indoor unit to execute a shutdown instruction, and to output an alarm dry contact signal to an alarm apparatus simultaneously to control the alarm apparatus to generate an alarm.

In some embodiments, if the voltage of the first power source on the mainboard of the indoor unit is larger than or equal to a first predetermined voltage and the voltage of the second power source on the mainboard of the indoor unit is larger than or equal to a second predetermined voltage, the back-up power source apparatus is controlled to enter the normal operation state.

In some embodiments, the operation state further includes a power-failure operation state, the back-up power source apparatus further includes a LED indicator light, and the method further includes: turning off the LED indicator light, if the back-up power source apparatus is in the power-failure operation state; controlling the LED indicator light to be always on, if the back-up power source apparatus is in the normal operation state; controlling the LED indicator light to output an indication in a first manner, if the back-up power source apparatus is in the protection operation state; controlling the LED indicator light to output an indication in a second manner, if the back-up power source apparatus is in the alarm operation state; and controlling the LED indicator light to output an indication in a third manner, if the back-up power source apparatus is in the back-up operation state.

Additional aspects and advantages of embodiments of present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present invention will become apparent and more readily appreciated from the following descriptions made with reference to the accompanying drawings, in which:

FIG. 1 is a block diagram of a back-up power source apparatus in an indoor unit of a multi-split air conditioning system according to an embodiment of the present disclosure;

FIG. 2 is a circuit diagram of back-up power source output by a back-up power source apparatus in an indoor unit of a multi-split air conditioning system according to an embodiment of the present disclosure;

FIG. 3 is a circuit diagram of a control circuit in a back-up power source apparatus in an indoor unit of a multi-split air conditioning system according to an embodiment of the present disclosure; and

FIG. 4 is a flowchart of a controlling method for a back-up power source apparatus in an indoor unit of a multi-split air conditioning system according to an embodiment of the present disclosure.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. The embodiments described herein according to drawings are explanatory and illustrative, not construed to limit the present disclosure.

The following description provides a plurality of embodiments or examples used to achieve different structures of the present disclosure. In order to simplify the publication of the present disclosure, components and arrangements of some non-limiting embodiments are described in the following, which are only explanatory and not construed to limit the present disclosure. In addition, the present disclosure may repeat the reference number and/or letter in different embodiments for the purpose of simplicity and clarity, and the repeat does not indicate the relationship of the plurality of embodiments and/or arrangements. Moreover, in description of the embodiments, the structure of a second feature “above” a first feature may include an embodiment in which the first and second features contact with each other directly, and also may include another embodiment in which a further feature is formed between the first and second features, and thus the first and second features may not contact directly with each other.

In the description of the present disclosure, unless specified or limited otherwise, it should be noted that, terms “mounted,” “connected” and “coupled” may be understood broadly, such as an electronic connection, a mechanical connection, an inner communication between two elements, a direct connection, or an indirect connection via intermediary. Those having ordinary skills in the art should understand the specific meanings in the present disclosure according to specific situations.

In the following, a back-up power source apparatus in an indoor unit of a multi-split air conditioning system, a multi-split air conditioning system and a controlling method for a back-up power source apparatus in an indoor unit of a multi-split air conditioning system according to embodiments will be described with reference to the drawings.

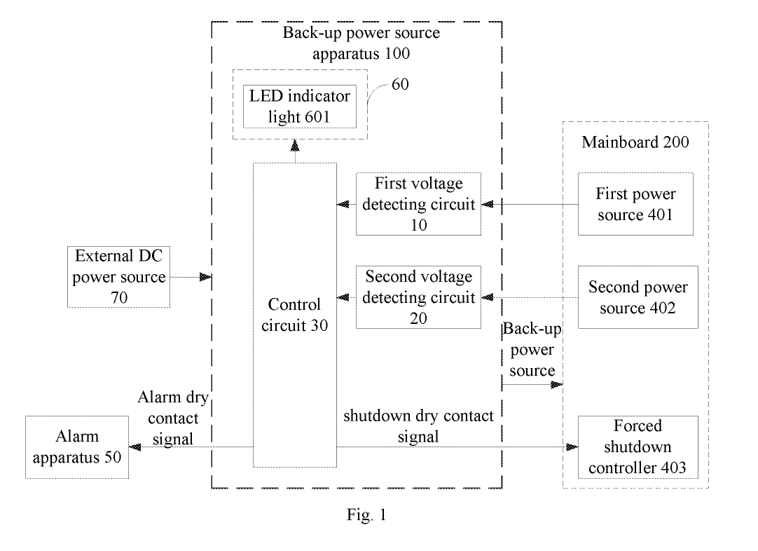

FIG. 1 is a block diagram of a back-up power source apparatus in an indoor unit of a multi-split air conditioning system according to an embodiment of the present disclosure. As shown in FIG. 1, the back-up power source apparatus 100 in an indoor unit of a multi-split air conditioning system includes a first voltage detecting circuit 10, a second voltage detecting voltage 20 and a control circuit 30.

The first voltage detecting circuit 10 is configured to detect a voltage of a first power source 401 on a mainboard 200 of the indoor unit in real time. The second voltage detecting circuit 20 is configured to detect a voltage of a second power source 402 on the mainboard 200 of the indoor unit in real time. The control circuit 30 is connected with the first voltage detecting circuit 10 and the second voltage detecting circuit 10 respectively, and is configured to control the back-up power source apparatus 100 to enter a corresponding operation state according to the voltage of the first power source 401 on the mainboard 200 of the indoor unit and/or the voltage of the second power source 402 on the mainboard 200 of the indoor unit, in which the operation state includes: a normal operation state, a protection operation state, a back-up operation state and an alarm operation state.

In an embodiment of the present disclosure, the first power source 401 on the mainboard 200 of the indoor unit may be configured as a 12V DC power source, and the second power source 402 on the mainboard 200 of the indoor unit may be configured as a 5V DC power source.

In an embodiment of the present disclosure, as shown in FIG. 1, the back-up power source apparatus further includes an indicator light module 60. The indicator light module 60 is connected with the control circuit 30, and is configured to output an indication under a control of the control circuit 30.

In an embodiment of the present disclosure, the indicator light module 60 includes a LED indicator light 601, and the operation state further includes a power-failure operation state of the back-up power source apparatus 100. If the back-up power source apparatus 100 is in the power-failure operation state, the LED indicator light 601 is turned off; if the back-up power source apparatus 100 is in the normal operation state, the LED indicator light 601 is always on; if the back-up power source apparatus 100 is in the protection operation state, the LED indicator light 601 outputs an indication in a first manner; if the back-up power source apparatus 100 is in the alarm operation state, the LED indicator light 601 outputs an indication in a second manner; and if the back-up power source apparatus 100 is in the back-up operation state, the LED indicator light 601 outputs an indication in a third manner.

In an embodiment of the present disclosure, as shown in FIG. 1, the back-up power source apparatus 100 is further connected with an external DC power source 70, and the external DC power source 70 is configured to supply power to the back-up power source apparatus 100.

In an embodiment of the present disclosure, the external DC power source 70 may supply a low voltage DC power to the back-up power source apparatus 100 directly, and a power supply of the external DC power source 70 and a power supply of the mainboard 200 of the indoor unit may supply power independently of each other. In some embodiments, the external DC power source 70 may further have a power storage function. When the power supply of the external DC power source 70 is supplying power to the external DC power source 70, the power supply of the external DC power source 70 charges a storage battery in the external DC power source 70 and supplies the low voltage DC power to the back-up power source apparatus 100 directly. When the power supply of the external DC power source 70 has a power failure, the storage battery in the external DC power source 70 supplies the low voltage DC power to the back-up power source apparatus 100, and simultaneously the power supply of the external DC power source 70 and the power supply of the mainboard 200 of the indoor unit supply power together. In some embodiments, the external DC power source 70 may further have the power storage function and a photovoltaic conversion function. When the power supply of the external DC power source 70 is supplying power to the external DC power source 70, a photovoltaic conversion plate in the external DC power source 70 supplies power to charge the storage battery in the external DC power source 70, and simultaneously the power supply of the external DC power source 70 supplies the low voltage DC power to the back-up power source apparatus 100 directly. When the power supply of the external DC power source 70 has a power failure, the storage battery in the external DC power source 70 supplies the low voltage DC power to the back-up power source apparatus 100, and simultaneously the power supply of the external DC power source 70 and the power supply of the mainboard 200 of the indoor unit supply power together.

In an embodiment of the present disclosure, if the voltage of the first power source 401 on the mainboard 200 of the indoor unit is less than a first predetermined voltage and the control circuit 30 determines that a duration of the voltage of the first power source 401 on the mainboard 200 of the indoor unit less than the first predetermined voltage reaches a first predetermined time, the control circuit 30 controls the back-up power source apparatus 100 to enter the protection operation state. If the back-up power source apparatus 100 is in the protection operation state, the control circuit 30 outputs a shutdown dry contact signal to a forced shutdown controller 403 to force the indoor unit to execute a shutdown instruction.

In another embodiment of the present disclosure, if the voltage of the second power source 402 is less than a second predetermined voltage and the control circuit 30 determines that a duration of the voltage of the second power source 402 less than the second predetermined voltage reaches a first predetermined time, the control circuit 30 controls the back-up power source apparatus 100 to enter the alarm operation state. If the back-up power source apparatus 100 is in the alarm operation state, the control circuit 30 outputs a shutdown dry contact signal to a forced shutdown controller 403 to force the indoor unit to execute a shutdown instruction and outputs an alarm dry contact signal to an alarm apparatus 50 simultaneously to control the alarm apparatus 50 to generate an alarm.

According to a further embodiment of the present disclosure, the control circuit 30 controls the back-up power source apparatus 100 to enter the back-up operation state, if the voltage of the first power source 401 on the mainboard 200 of the indoor unit is less than a first predetermined voltage, the voltage of the second power source 402 on the mainboard 200 of the indoor unit is less than the second predetermined voltage, and the control circuit 30 determines that a duration of the voltage of the first power source 401 on the mainboard 200 of the indoor unit less than the first predetermined voltage reaches the first predetermined time and a duration of the voltage of the second power source 402 less than the second predetermined voltage reaches the first predetermined time. If the back-up power source apparatus 100 is in the back-up operation state, the control circuit 30 controls the back-up power source apparatus 100 to output a back-up power source to the mainboard 200 of the indoor unit, to output a shutdown dry contact signal to the forced shutdown controller 403 to force the indoor unit to execute a shutdown instruction, and to output an alarm dry contact signal to the alarm apparatus 50 simultaneously to control the alarm apparatus 50 to generate an alarm.

In yet another embodiment of the present disclosure, if the voltage of the first power source 401 on the mainboard 200 of the indoor unit is larger than or equal to the first predetermined voltage and the voltage of the second power source 402 on the mainboard 200 of the indoor unit is larger than or equal to the second predetermined voltage, the control circuit 30 controls the back-up power source apparatus 100 to enter the normal operation state.

In some embodiments of the present disclosure, the first predetermined voltage, the second predetermined voltage and the first predetermined time may be set according to actual conditions. For example, the first predetermined voltage may be +11.5V, the second predetermined voltage may be +2.5V, and the first predetermined time may be 3 seconds.

According to embodiments of the present disclosure, by disposing the back-up power source apparatus in the multi-split air conditioning system, the negative influences on the multi-split air conditioning system caused by an independent power failure of the indoor unit may be removed. In other words, when the supply of power of the indoor unit fails, the indoor unit is forced to be shut down, without affecting normal operations of other indoor units of the multi-split air conditioning system. In this way, the requirement that electric equipment in each room (such as a hotel room) should be incorporated into a master power switch may be satisfied, thus greatly broadening an application scope of the multi-split air conditioning system.

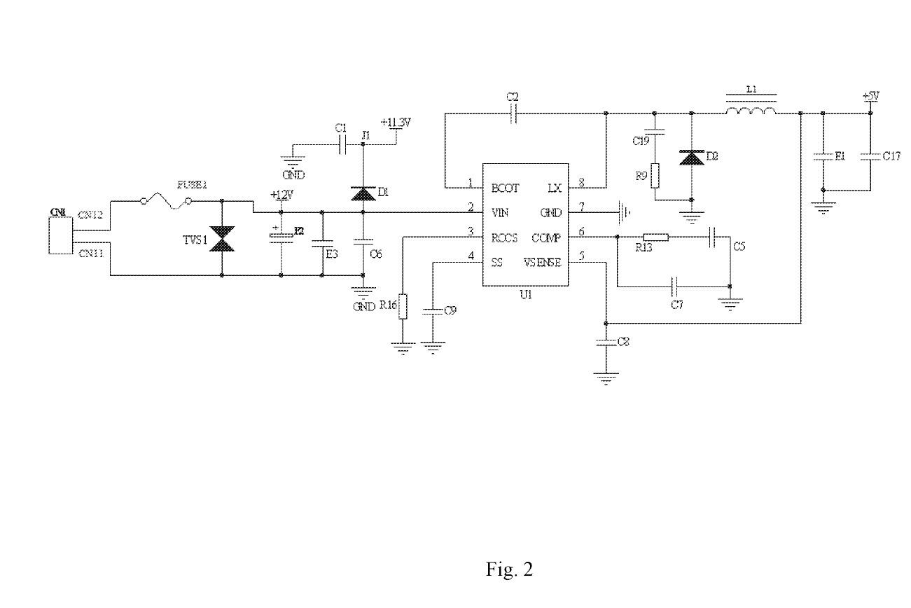

FIG. 2 is a circuit diagram of back-up power source output by a back-up power source apparatus in an indoor unit of a multi-split air conditioning system according to an embodiment of the present disclosure. As shown in FIG. 2, a circuit of the back-up power source output by the back-up power source apparatus in the indoor unit includes a first interface CN1, an automatic recoverable fuse FUSE1, a first diode D1, a first capacitor C1, a voltage stabilization chip U1 having first to eighth pins 1-8, a second capacitor C2 and a first inductor L1. A first terminal CN11 of the first interface CN1 is grounded, a second terminal CN12 of the first interface CN1 is connected with a first terminal of the automatic recoverable fuse FUSE1, a second terminal of the automatic recoverable fuse FUSE1 is connected with a positive electrode of the first diode D1 and the second pin 2 of the voltage stabilization chip U1, a negative electrode of the first diode D1 is connected with a first terminal of the first capacitor C1, a second of the first capacitor C1 is grounded, a first node J1 is formed between the negative electrode of the first diode D1 and the first terminal of the first capacitor C1, and a voltage with a value of +11.3V is output from the first node J1, the second capacitor C2 is connected between the first pin 1 and the eighth pin 8 of the voltage stabilization chip U1, the eighth pin 8 of the voltage stabilization U1 is connected with a first terminal of the first inductor L1, and a second terminal of the first inductor L1 outputs a voltage with a value of +5V.

In some embodiments of the present disclosure, the first interface CN1 is configured as a power input terminal of the back-up power source apparatus 100 and is connected with the external DC power source 70, and the external DC power source 70 may supply power to the back-up power source apparatus 100 via the first interface CN1. If the back-up power source apparatus 100 is in the back-up operation state, the circuit may output +11.3V and +5V DC power sources to supply power to the mainboard 200 of the indoor unit. Moreover, since an installation condition of the indoor unit of the multi-split air conditioning system is complex and the external DC power sources 70 such as a 12V DC power source purchased by users have different qualities, the automatic recoverable fuse FUSE1 is disposed in the back-up power source apparatus 100 of the multi-split air conditioning system in order to prevent damage on the back-up power source apparatus 100 due to a short circuit of the external DC power source 70. In some embodiments, when a circuit current of the back-up power source apparatus 100 is larger than a preset current such as 0.5 A, the automatic recoverable fuse FUSE1 is disconnected to protect the back-up power source apparatus 100. In some embodiments, when the circuit current of the back-up power source apparatus 100 returns to normal, the automatic recoverable fuse FUSE1 recovers automatically such that power is supplied to the back-up power source apparatus 100. Such as described in these embodiments, with the automatic recoverable fuse FUSE1, each element in the back-up power source apparatus 100 may be protected from being damaged.

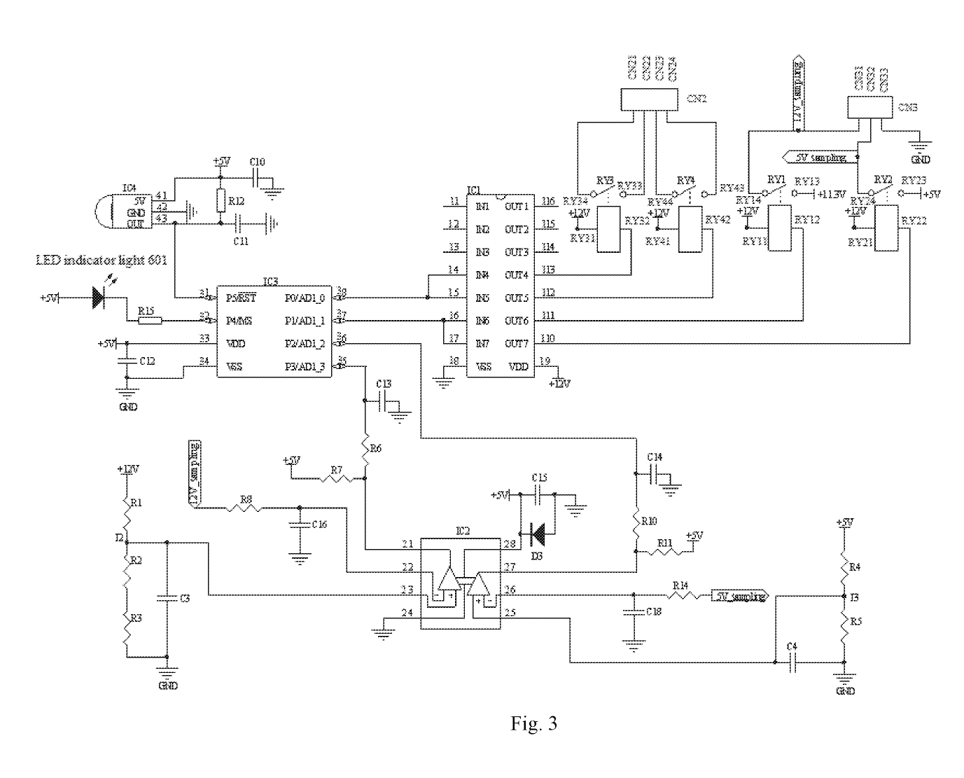

FIG. 3 is a circuit diagram of a control circuit in a back-up power source apparatus in an indoor unit of a multi-split air conditioning system according to an embodiment of the present disclosure. As shown in FIG. 3, the control circuit in the back-up power source apparatus includes a first control chip IC1 having first to sixteenth pins 11-116, a second interface CN2 having first to fourth terminals CN21-24, a third interface CN3 having first to third terminals CN31-33, a first relay RY1 having first to fourth terminals RY11-14, a second relay RY2 having first to fourth terminals RY21-24, a third relay RY3 having first to fourth terminals RY31-34, a fourth relay RY4 having first to fourth terminals RY41-44, a second control chip IC2 having first to eighth pins 21-28, a first resistor R1, a second resistor R2, a third resistor R3, a fourth resistor R4, a fifth resistor R5, a third capacitor C3 and a fourth capacitor C4. The thirteenth pin 113 of the first control chip IC1 is connected with the second terminal RY32 of the third relay RY3, the first terminal RY31 of the third relay RY3 is connected with a +12V power source, the third terminal RY33 of the third relay RY3 is connected with the second terminal CN22 of the second interface CN2, and the fourth terminal RY34 of the third relay RY3 is connected with the first terminal CN21 of the second interfaced CN2. The twelve pin 112 of the first control chip IC1 is connected with the second terminal RY42 of the fourth relay RY4, the first terminal RY41 of the fourth relay RY4 is connected with a +12V power source, the third terminal RY43 of the fourth relay RY4 is connected with the fourth terminal CN24 of the second interface CN2, and the fourth terminal RY44 of the fourth relay RY4 is connected with the third terminal CN23 of the second interface CN2. The eleventh pin 111 of the first control chip IC1 is connected with the second terminal RY12 of the first relay RY1, the first terminal RY11 of the first relay RY1 is connected with a +12V power source, the third terminal RY13 of the first relay RY1 is connected with a +11.3V power source, and the fourth terminal RY14 of the first relay RY1 is connected with the first terminal CN31 of the third interface CN3. A first sampling point 12V sampling is formed between the fourth terminal RY14 of the first relay RY1 and the first terminal CN31 of the third interface CN3, and is configured to sample the voltage of the first power source 401 detected by the first voltage detecting circuit 10. The tenth pin 110 of the first control chip IC1 is connected with the second terminal RY22 of the second relay RY2, the first terminal RY21 of the second relay RY2 is connected with a +12V power source, the third terminal RY23 of the second relay RY2 is connected with a +5V power source, and the fourth terminal RY24 of the second relay RY2 is connected with the second terminal CN32 of the third interface CN3. A second sampling point 5V_sampling is formed between the fourth terminal RY44 of the second relay RY2 and the second terminal CN32 of the third interface CN3, and is configured to sample the voltage of the second power source 402 detected by the second voltage detecting circuit 20. The third terminal CN33 of the third interface CN3 is grounded. The first resistor R1, the second resistor R2 and the third resistor R3 are connected in series, a first terminal of the first resistor R1 is connected with a +12V power source, a second terminal of the first resistor R1 is connected with a first terminal of the second resistor R2, a first terminal of the third capacitor C3 and the third pin 23 of the second control IC2 respectively. A second terminal of the second resistor R2 is connected with a first terminal of the third resistor R3, and both a second terminal of the third resistor R3 and a second terminal of the third capacitor C3 are grounded. A second node J2 is formed between the second terminal of the first resistor R1 and the first terminal of the second resistor R2, and is configured to output the first predetermined voltage. The fourth resistor R4 is connected with the fifth resistor R5 in series. A first terminal of the fourth resistor R4 is connected with a +5V power source, and a second terminal of the fourth resistor R4 is connected with a first terminal of the fifth resistor R5, a first terminal of the fourth capacitor C4 and the fifth pin 25 of the second control chip IC2 respectively. Both a second terminal of the fifth resistor R5 and a second terminal of the fourth capacitor C4 are grounded. A third node J3 is formed between the fourth resistor R4 and the fifth resistor R5, and is configured to output the second predetermined voltage.

In some embodiments of the present disclosure, the first terminal CN21 and the second terminal CN22 of the second interface CN2 are configured as output terminals of the alarm dry contact signal, and the third terminal CN23 and the fourth terminal CN24 of the second interface CN2 are configured as output terminals of the shutdown dry contact signal. The third interface CN3 is not only configured as a voltage sampling terminals of the first power source 401 and the second power source 402 on the mainboard 200 of the indoor unit, but also configured as a power output terminal of the back-up power source to supply power to the mainboard 200 of the indoor unit. In some embodiments, when the third interface CN3 is the voltage sampling terminals of the first power source 401 and the second power source 402 on the mainboard 200 of the indoor unit, the third terminal RY13 and the fourth terminal RY14 of the first rely RY1 are disconnected, and the control circuit 30 samples the voltage of the first power source 401 detected by the first voltage detecting circuit 10 via the first sampling point 12V sampling; and the third terminal RY23 and the fourth terminal RY24 of the second rely RY2 are disconnected, the control circuit 30 samples the voltage of the second power source 402 detected by the second voltage detecting circuit 20 via the second sampling point 5V sampling. In some embodiments, when the third interface CN3 is configured as the power output terminal of the back-up power source to supply power to the mainboard 200 of the indoor unit, the third terminal RY13 and the fourth terminal RY14 of the first rely RY1 are connected, and the first terminal CN31 of the third interface CN3 outputs a voltage with a value of +11.3V to supply power to the first power source 401 on the mainboard 200 of the indoor unit; and the third terminal RY23 and the fourth terminal RY24 of the second rely RY2 are connected, and the second terminal CN32 of the third interface CN3 outputs a voltage with a value of +5V to supply power to the second power source 402 on the mainboard 200 of the indoor unit. In some embodiments, the first predetermined voltage and the second predetermined voltage each may be reset by changing resistances of resistors. For example, the first predetermined voltage may be reset by changing resistances of the first resistor R1, the second resistor R2 and the third resistor R3. For example, the second predetermined voltage may be reset by changing resistances of the fourth resistor R4 and the fifth resistor R5.

The first predetermined voltage is calculated according to equation (1) as follows:

V1=V_{CC1}−V_{CC1}×R1/(R1+R2+R3) (1)

where V1 represents the first predetermined voltage and V_{CC1} is +12V from a DC power source. The second predetermined voltage is calculated according to equation (2) as follows:

V2=V_{CC2}−V_{CC2}×R4/(R4+R5) (2)

where V2 represents the second predetermined voltage and V_{CC2} is +5V from a DC power source.

In some embodiments, after starting the multi-split air conditioning system, the first voltage detecting circuit 10 and the second voltage detecting circuit 20 of the back-up power source apparatus 100 detect the voltage (such as 12V) of the first power source 401 on the mainboard 200 of the indoor unit and the voltage (such 5V) of the second power source 402 on the mainboard 200 of the indoor unit in real time. If the voltage of the first power source 401 on the mainboard 200 of the indoor unit is less than +11.5V, the control circuit 30 determines whether a duration of the voltage of the first power source 401 on the mainboard 200 of the indoor unit less than +11.5V reaches a first predetermined time such as 3 s. If the duration reaches the first predetermined time such as 3 s, the control circuit 30 controls the back-up power source apparatus 100 to enter the protection operation state. In the present embodiment, the fourth terminal RY44 and the third terminal RY43 of the fourth rely RY4 in the control circuit 30 are connected, the control circuit 30 outputs a shutdown dry contact signal to the forced shutdown controller 403 to force the indoor unit to execute a shutdown instruction, and the indoor unit may not receive a starting instruction so as to realize a pre-protection function. Simultaneously, the third terminal RY33 and the fourth terminal RY34 of the third rely RY3 in the control circuit 30 are connected, the control circuit 30 outputs an alarm dry contact signal to the alarm apparatus 50 to control the alarm apparatus 50 to generate an alarm, and the LED indicator light 601 outputs an indication in a first manner, such as flashing 3 times every two seconds. In this way, an error action of the control circuit 30 due to a voltage fluctuation of the first power source 401 may be prevented.

In some embodiments, if the voltage of the second power source 402 on the mainboard 200 of the indoor unit detected by the second voltage detecting circuit 20 is less than +2.5V and the voltage of the first power source 401 on the mainboard 200 of the indoor unit detected by the first voltage detecting circuit 10 is equal to or larger than +11.5V, the control circuit 30 determines whether a duration of the voltage of the second power source 402 on the mainboard 200 of the indoor unit less than +2.5V reaches the first predetermined time such as 3 s. If the duration reaches the first predetermined time such as 3 s, the control circuit 30 controls the back-up power source apparatus 100 to enter the alarm operation state. In the present embodiment, the fourth terminal RY44 and the third terminal RY43 of the fourth rely RY4 in the control circuit 30 are connected, and the control circuit 30 outputs a shutdown dry contact signal to the forced shutdown controller 403 to force the indoor unit to execute a shutdown instruction. Simultaneously, the third terminal RY33 and the fourth terminal RY34 of the third rely RY3 in the control circuit 30 are connected, the control circuit 30 outputs an alarm dry contact signal to the alarm apparatus 50 so as to control the alarm apparatus 50 to generate an alarm, and the LED indicator light 601 outputs an indication in a second manner, such as flashing 5 times every two seconds. In this way, an error action of the control circuit 30 due to a voltage fluctuation of the second power source 402 may be prevented.

In some embodiments, if the voltage of the first power source 401 on the mainboard 200 of the indoor unit is less than +11.5V and the voltage of the second power source 402 on the mainboard 200 of the indoor unit is less than +2.5V, the control circuit 30 determines whether the duration of the voltage of the first power source 401 on the mainboard 200 of the indoor unit less than +11.5V reaches the first predetermined time such as 3 s and whether the duration of the voltage of the second power source 402 on the mainboard 200 of the indoor unit less than +2.5V reaches the first predetermined time such as 3 s. If the control circuit 30 determines that the duration of the voltage of the first power source 401 on the mainboard 200 of the indoor unit less than +11.5V reaches the first predetermined time such as 3 s and the duration of the voltage of the second power source 402 on the mainboard 200 of the indoor unit less than +2.5V reaches the first predetermined time such as 3 s, the control circuit 30 controls the back-up power source apparatus 100 to enter the back-up operation state. In the present embodiment, the control circuit 30 controls the back-up power source apparatus 100 to output +11.3V, +5V and GND back-up power sources to the mainboard 200 of the indoor unit. The fourth terminal RY44 and the third terminal RY43 of the fourth rely RY4 in the control circuit 30 are connected, the control circuit 30 outputs a shutdown dry contact signal to the forced shutdown controller 403 to force the indoor unit to execute a shutdown instruction, and the indoor unit may not receive a starting instruction so as to realize a pre-protection function. Simultaneously, the third terminal RY33 and the fourth terminal RY34 of the third rely RY3 in the control circuit 30 are connected, the control circuit 30 outputs an alarm dry contact signal to the alarm apparatus 50 to control the alarm apparatus 50 to generate an alarm, and the LED indicator light 601 outputs an indication in a third manner, such as flashing 4 times every two seconds. In this way, an error action of the control circuit 30 due to voltage fluctuations of the first power source 401 and the second power source 402 may be prevented.

In some embodiments, if the voltage of the first power source 401 on the mainboard 200 of the indoor unit is larger than +11.5V and the voltage of the second power source 402 on the mainboard 200 of the indoor unit is larger than +2.5V, the control circuit 30 controls the back-up power source apparatus 100 to enter the normal operation state and the LED indicator light 601 is always on.

In some embodiments, if the back-up power source apparatus 100 is in the power-failure operation state, the LED indicator light 601 is turned off. In the present embodiment, the back-up power source apparatus 100 is not working. With the back-up power source apparatus in the indoor unit of the multi-split air conditioning system according to embodiments of the present disclosure, the first voltage detecting circuit detects the voltage of the first power source on the mainboard of the indoor unit in real time, the second voltage detecting circuit detects the voltage of the second power source on the mainboard of the indoor unit in real time, and the control circuit controls the back-up power source apparatus to enter the corresponding operation state according to the voltage of the first power source on the mainboard of the indoor unit and/or the voltage of the second power source on the mainboard of the indoor unit. Accordingly, the back-up power source apparatus in the indoor unit of the multi-split air conditioning system according to embodiments of the present disclosure determines whether the supply of power of the indoor unit fails by detecting the voltages of the first power source and the second power source on the mainboard of the indoor unit in real time. In case of a power failure of the indoor unit, the back-up power source apparatus enters the corresponding operation state, and thus the multi-split air conditioning system can operate normally even when the supply of power of the indoor unit fails. In this way, a series of negative influences on the multi-split air conditioning system, which are caused by a fact that an electronic expansion valve in the indoor unit remains in the current state because of the power failure of the indoor unit, may be removed, thus ensuring a reliable operation of the multi-split air conditioning system. In addition, the back-up power source apparatus in the indoor unit may be implemented completely by a weak current control, and thus can operate safely and reliably.

Embodiments of the present disclosure further provide a multi-split air conditioning system, including the above-identified back-up power source in an indoor unit of a multi-split air conditioning system.

With the back-up power source apparatus in the indoor unit of the multi-split air conditioning system, the multi-split air conditioning system according to embodiments of the present disclosure can operate normally even when the supply of power of the indoor unit fails. In addition, a series of negative influences on the multi-split air conditioning system, which are caused by a fact that an electronic expansion valve in the indoor unit remains in the current state because of an independent power failure of the indoor unit, may be removed, thus ensuring a reliable operation of the multi-split air conditioning system.

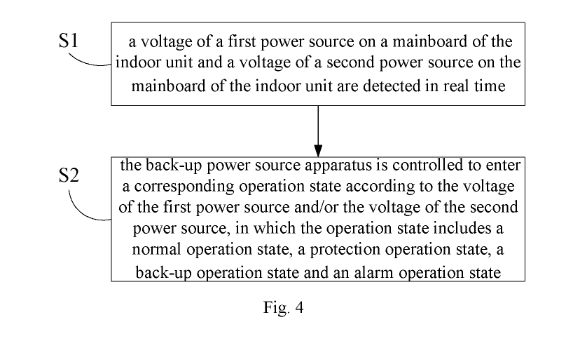

FIG. 4 is a flowchart of a controlling method for a back-up power source apparatus in an indoor unit of a multi-split air conditioning system according to an embodiment of the present disclosure. As shown in FIG. 4, the controlling method includes following steps.

At step S1, a voltage of a first power source on a mainboard of the indoor unit and a voltage of a second power source on the mainboard of the indoor unit are detected in real time.

At step S2, the back-up power source apparatus is controlled to enter a corresponding operation state according to the voltage of the first power source on the mainboard of the indoor unit and/or the voltage of the second power source on the mainboard of the indoor unit, in which the operation state includes: a normal operation state, a protection operation state, a back-up operation state and an alarm operation state.

In an embodiment of the present disclosure, if the voltage of the first power source on the mainboard of the indoor unit is less than a first predetermined voltage and it is determined that a duration of the voltage of the first power source on the mainboard of the indoor unit less than the first predetermined voltage reaches a first predetermined time, the back-up power source apparatus is controlled to enter the protection operation state. If the back-up power source apparatus is in the protection operation state, a shutdown dry contact signal is output to a forced shutdown controller to force the indoor unit to execute a shutdown instruction, and an alarm dry contact signal is output to an alarm apparatus simultaneously to control the alarm apparatus to generate an alarm.

In an embodiment of the present disclosure, if the voltage of the second power source on the mainboard of the indoor unit is less than a second predetermined voltage and it is determined that a duration of the voltage of the second power source less than the second predetermined voltage reaches a first predetermined time, the back-up power source apparatus is controlled to enter the alarm operation state. If the back-up power source apparatus is in the alarm operation state, a shutdown dry contact signal is output to the forced shutdown controller to force the indoor unit to execute a shutdown instruction, and an alarm dry contact signal is output to the alarm apparatus simultaneously to control the alarm apparatus to generate an alarm.

In an embodiment of the present disclosure, the back-up power source apparatus is controlled to enter the back-up operation state, if the voltage of the first power source on the mainboard of the indoor unit is less than the first predetermined voltage, the voltage of the second power source on the mainboard of the indoor unit is less than the second predetermined voltage, and it is determined that the duration of the voltage of the first power source on the mainboard of the indoor unit less than the first predetermined voltage reaches the first predetermined time and a duration of the voltage of the second power source less than the second predetermined voltage reaches the first predetermined time. If the back-up power source apparatus is in the back-up operation state, the back-up power source apparatus is controlled to output a back-up power source to the mainboard of the indoor unit, to output a shutdown dry contact signal to a forced shutdown controller to force the indoor unit to execute a shutdown instruction, and to output an alarm dry contact signal to the alarm apparatus simultaneously to control the alarm apparatus to generate an alarm.

In an embodiment of the present disclosure, if the voltage of the first power source on the mainboard of the indoor unit is larger than or equal to the first predetermined voltage and the voltage of the second power source on the mainboard of the indoor unit is larger than or equal to the second predetermined voltage, the back-up power source apparatus is controlled to enter the normal operation state.

In an embodiment of the present disclosure, the operation state further includes a power-failure operation state. In some embodiments, a LED indicator light in the back-up power source apparatus is turned off, if the back-up power source apparatus is in the power-failure operation state. In some embodiments, the LED indicator light is always on, if the back-up power source apparatus is in the normal operation state. In some embodiments, the LED indicator light is controlled to output an indication in a first manner, if the back-up power source apparatus is in the protection operation state. In some embodiments, the LED indicator light is controlled to output an indication in a second manner, if the back-up power source apparatus is in the alarm operation state. In some embodiments, the LED indicator light is controlled to output an indication in a third manner, if the back-up power source apparatus is in the back-up operation state.

In some embodiments, as shown in FIGS. 2 and 3, after starting the multi-split air conditioning system, the first voltage detecting circuit and the second voltage detecting circuit of the back-up power source apparatus in the indoor unit detect the voltage (such as 12V) of the first power source on the mainboard of the indoor unit and the voltage (such 5V) of the second power source on the mainboard of the indoor unit in real time respectively, and the LED indicator light is always on. If the voltage of the first power source on the mainboard of the indoor unit is less than +11.5V, the control circuit determines whether the duration of the voltage of the first power source on the mainboard of the indoor unit less than +11.5V reaches the first predetermined time such as 3 s. If the duration reaches the first predetermined time such as 3 s, the control circuit controls the back-up power source apparatus to enter the protection operation state. In the present embodiment, the control circuit outputs a shutdown dry contact signal to the forced shutdown controller to force the indoor unit to execute a shutdown instruction, and the indoor unit may not receive a starting instruction so as to realize a pre-protection function. Simultaneously, the control circuit outputs an alarm dry contact signal to the alarm apparatus to control the alarm apparatus to generate an alarm, and the LED indicator light outputs an indication in a first manner, such as flashing 3 times every two seconds. In this way, an error action of the control unit due to a voltage fluctuation of the first power source may be prevented.

In some embodiments, if the voltage of the second power source on the mainboard of the indoor unit detected by the second voltage detecting circuit is less than +2.5V and the voltage of the first power source on the mainboard of the indoor unit detected by the first voltage detecting circuit is larger than +11.5V, the control circuit determines whether the duration of the voltage of the second power source on the mainboard of the indoor unit less than +2.5V reaches the first predetermined time such as 3 s. If the duration reaches the first predetermined time such as 3 s, the control circuit controls the back-up power source apparatus to enter the alarm operation state. In the present embodiment, the control circuit outputs a shutdown dry contact signal to the forced shutdown controller to force the indoor unit to execute a shutdown instruction, and the control circuit outputs an alarm dry contact signal to the alarm apparatus simultaneously to control the alarm apparatus to generate an alarm, and the LED indicator light outputs an indication in a second manner, such as flashing 5 times every two seconds. In this way, an error action of the control unit due to a voltage fluctuation of the second power source may be prevented.

In some embodiments, if the voltage of the first power source on the mainboard of the indoor unit is less than +11.5V and the voltage of the second power source on the mainboard of the indoor unit is less than +2.5V, the control circuit determines whether the duration of the voltage of the first power source on the mainboard of the indoor unit less than +11.5V reaches the first predetermined time such as 3 s and whether the duration of the voltage of the second power source on the mainboard of the indoor unit less than +2.5V reaches the first predetermined time such as 3 s. If the control circuit determines that the duration of the voltage of the first power source on the mainboard of the indoor unit less than +11.5V reaches the first predetermined time such as 3 s and the duration of the voltage of the second power source on the mainboard of the indoor unit less than +2.5V reaches the first predetermined time such as 3 s, the control circuit controls the back-up power source apparatus to enter the back-up operation state. In the present embodiment, the control circuit controls the back-up power source apparatus in the indoor unit to output +11.3V, +5V and GND back-up power sources to the mainboard of the indoor unit, the control circuit outputs a shutdown dry contact signal to the forced shutdown controller to force the indoor unit to execute a shutdown instruction and the indoor unit may not receive a starting instruction so as to realize the pre-protection function. Simultaneously, the control circuit outputs an alarm dry contact signal to the alarm apparatus to control the alarm apparatus to generate an alarm, and the LED indicator light outputs an indication in a third manner, such as flashing 4 times every two seconds.

In this way, an error action of the control unit due to voltage fluctuations of the first and second power sources may be prevented.

In some embodiments, if the back-up power source apparatus in the indoor unit is in any of the protection operation state, the alarm operation state and the back-up operation state and the voltage of the first power source on the mainboard of the indoor unit is larger than or equal to +11.5V and the voltage of the second power source on the mainboard of the indoor unit is larger than or equal to +2.5V, the control circuit controls the back-up power source apparatus to enter the normal operation state and the LED indicator light is always on.

In some embodiments, if the back-up power source apparatus is in the power-failure operation state, the LED indicator light in the back-up power source apparatus is turned off.

With the controlling method for the back-up power source apparatus in the indoor unit of the multi-split air conditioning system, the voltage of the first power source on the mainboard of the indoor unit and the voltage of the second power source on the mainboard of the indoor unit are detected in real time, and the back-up power source apparatus is controlled to enter the corresponding operation state according to the voltage of the first power source on the mainboard of the indoor unit and/or the voltage of the second power source on the mainboard of the indoor unit, and thus the multi-split air conditioning system can operate normally even when the supply of power of the indoor unit fails. In this way, a series of negative influences on the multi-split air conditioning system, which are caused by a fact that an electronic expansion valve in the indoor unit remains in the current state because of the independent power failure of the indoor unit, may be removed, thus ensuring a reliable operation of the multi-split air conditioning system.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It is understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as an standalone product, the integrated module may be stored in a computer readable storage medium.

The storage medium mentioned above may be read-only memories, magnetic disks or CD, etc.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the phrases throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A back-up power source apparatus in an indoor unit of a multi-split air conditioning system, comprising:
a first voltage detecting circuit configured to detect a voltage of a first power source on a mainboard of the indoor unit in real time;
a second voltage detecting circuit configured to detect a voltage of a second power source on the mainboard of the indoor unit in real time;
a control circuit connected with the first voltage detecting circuit and the second voltage detecting circuit and configured to control the back-up power source apparatus to enter a corresponding operation state according to the voltage of the first power source on the mainboard of the indoor unit and/or the voltage of the second power source on the mainboard of the indoor unit, wherein the operation state comprises: a normal operation state, a protection operation state, a back-up operation state and an alarm operation state.

2. The back-up power source apparatus according to claim 1, wherein
if the voltage of the first power source on the mainboard of the indoor unit is less than a first predetermined voltage and the control circuit determines that a duration of the voltage of the first power source on the mainboard of the indoor unit less than the first predetermined voltage reaches a first predetermined time, the control circuit controls the back-up power source apparatus to enter the protection operation state, and
if the back-up power source apparatus is in the protection operation state, the control circuit outputs a shutdown dry contact signal to a forced shutdown controller to force the indoor unit to execute a shutdown instruction.

3. The back-up power source apparatus according to claim 1, wherein
if the voltage of the second power source is less than a second predetermined voltage and the control circuit determines that a duration of the voltage of the second power source less than the second predetermined voltage reaches a first predetermined time, the control circuit controls the back-up power source apparatus to enter the alarm operation state, and
if the back-up power source apparatus is in the alarm operation state, the control circuit outputs a shutdown dry contact signal to a forced shutdown controller to force the indoor unit to execute a shutdown instruction, and outputs an alarm dry contact signal to an alarm apparatus simultaneously to control the alarm apparatus to generate an alarm.

4. The back-up power source apparatus according to claim 1, wherein
the control circuit controls the back-up power source apparatus to enter the back-up operation state, if the voltage of the first power source on the mainboard of the indoor unit is less than a first predetermined voltage, the voltage of the second power source on the mainboard of the indoor unit is less than a second predetermined voltage, and the control circuit determines that a duration of the voltage of the first power source on the mainboard of the indoor unit less than the first predetermined voltage reaches a first predetermined time and a duration of the voltage of the second power source less than the second predetermined voltage reaches the first predetermined time, and
if the back-up power source apparatus is in the back-up operation state, the control circuit controls the back-up power source apparatus to output a back-up power source to the mainboard of the indoor unit, to output a shutdown dry contact signal to a forced shutdown controller to force the indoor unit to execute a shutdown instruction, and to output an alarm dry contact signal to an alarm apparatus simultaneously to control the alarm apparatus to generate an alarm.

5. The back-up power source apparatus according to claim 1, wherein
if the voltage of the first power source on the mainboard of the indoor unit is larger than or equal to a first predetermined voltage and the voltage of the second power source on the mainboard of the indoor unit is larger than or equal to a second predetermined voltage, the control circuit controls the back-up power source apparatus to enter the normal operation state.

6. The back-up power source apparatus according to any one of claims 1-5, further comprising:
an indicator light module connected with the control circuit and configured to output an indication under a control of the control circuit.

7. The back-up power source apparatus according to claim 6, wherein the indicator light module comprises a LED indicator light and the operation state further comprises a power-failure operation state, wherein
if the back-up power source apparatus is in the power-failure operation state, the LED indicator light is turned off;
if the back-up power source apparatus is in the normal operation state, the LED indicator light is always on;
if the back-up power source apparatus is in the protection operation state, the LED indicator light outputs an indication in a first manner;
if the back-up power source apparatus is in the alarm operation state, the LED indicator light outputs an indication in a second manner; and
if the back-up power source apparatus is in the back-up operation state, the LED indicator light outputs an indication in a third manner.

8. The back-up power source apparatus according to any of claims 1-7, wherein the first power source on the mainboard of the indoor unit is configured as a 12V DC power source and the second power source on the mainboard of the indoor unit is configured as a 5V DC power source.

9. The back-up power source apparatus according to any of claims 1-8, wherein the back-up power source apparatus is further connected with an external DC power source, and the external DC power source is configured to supply power to the back-up power source apparatus.

10. A multi-split air conditioning system comprising a back-up power source apparatus in an indoor unit of a multi-split air conditioning system according to any one of claims 1-9.

11. A controlling method for a back-up power source apparatus in an indoor unit of a multi-split air conditioning system, comprising:
detecting a voltage of a first power source on a mainboard of the indoor unit and a voltage of a second power source on the mainboard of the indoor unit in real time;
controlling the back-up power source apparatus to enter a corresponding operation state according to the voltage of the first power source on the mainboard of the indoor unit and/or the voltage of the second power source on the mainboard of the indoor unit, wherein the operation state comprises: a normal operation state, a protection operation state, a back-up operation state and an alarm operation state.

12. The controlling method according to claim 11, wherein
if the voltage of the first power source on the mainboard of the indoor unit is less than a first predetermined voltage and it is determined that a duration of the voltage of the first power source on the mainboard of the indoor unit less than the first predetermined voltage reaches a first predetermined time, the back-up power source apparatus is controlled to enter the protection operation state, and
if the back-up power source apparatus is in the protection operation state, a shutdown dry contact signal is output to a forced shutdown controller to force the indoor unit to execute a shutdown instruction.

13. The controlling method according to claim 11, wherein
if the voltage of the second power source on the mainboard of the indoor unit is less than a second predetermined voltage and it is determined that a duration of the voltage of the second power source less than the second predetermined voltage reaches a first predetermined time, the back-up power source apparatus is controlled to enter the alarm operation state, and
if the back-up power source apparatus is in the alarm operation state, a shutdown dry contact signal is output to a forced shutdown controller to force the indoor unit to execute a shutdown instruction, and an alarm dry contact signal is output to an alarm apparatus simultaneously to control the alarm apparatus to generate an alarm.

14. The controlling method according to claim 11, wherein
the back-up power source apparatus is controlled to enter the back-up operation state, if the voltage of the first power source on the mainboard of the indoor unit is less than a first predetermined voltage, the voltage of the second power source on the mainboard of the indoor unit is less than a second predetermined voltage, and it is determined that a duration of the voltage of the first power source on the mainboard of the indoor unit less than the first predetermined voltage reaches a first predetermined time and a duration of the voltage of the second power source less than the second predetermined voltage reaches the first predetermined time, and
if the back-up power source apparatus is in the back-up operation state, the back-up power source apparatus is controlled to output a back-up power source to the mainboard of the indoor unit, to output a shutdown dry contact signal to a forced shutdown controller to force the indoor unit to execute a shutdown instruction, and to output an alarm dry contact signal to an alarm apparatus simultaneously to control the alarm apparatus to generate an alarm.

15. The controlling method according to claim 11, wherein if the voltage of the first power source on the mainboard of the indoor unit is larger than or equal to a first predetermined voltage and the voltage of the second power source on the mainboard of the indoor unit is larger than or equal to a second predetermined voltage, the back-up power source apparatus is controlled to enter the normal operation state.

16. The controlling method according to claim any one of claims 11-15, wherein the back-up power source apparatus further comprises an indicator light module, and the controlling method further comprises: outputting by the indicator light module an indication under a control of the control circuit.

17. The controlling method according to claim 16, wherein the indicator light module comprises a LED indicator light and the operation state further comprises a power-failure operation state, and the controlling method further comprises:
turning off the LED indicator light, if the back-up power source apparatus is in the power-failure operation state;
controlling the LED indicator light to be always on, if the back-up power source apparatus is in the normal operation state;
controlling the LED indicator light to output an indication in a first manner, if the back-up power source apparatus is in the protection operation state;
controlling the LED indicator light to output an indication in a second manner, if the back-up power source apparatus is in the alarm operation state; and
controlling the LED indicator light to output an indication in a third manner, if the back-up power source apparatus is in the back-up operation state.
